(19) United States
(12) Patent Application Publication
(10) Pub. No.: US 2006/0071904 A1
(43) Pub. Date: Apr. 6, 2006

(54) Method of and apparatus for executing function using combination of user's key input and motion

(75) Inventors: Sung-jung Cho, Suwon-si (KR); Soon-joo Kwon, Seongnam-si (KR); Wook Chang, Seoul (KR); Dong-yoon Kim, Seoul (KR); Jong-koo Oh, Yongin-si (KR); Eun-seok Choi, Anyang-si (KR); Won-chul Bang, Seongnam-si (KR); Joon-kee Cho, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/195,603

(22) Filed: Aug. 3, 2005

(30) Foreign Application Priority Data
Oct. 5, 2004 (KR) 10-2004-0079202
Dec. 29, 2004 (KR) 10-2004-0115071

(51) Int. Cl. G09G 5/00

(52) U.S. Cl. 345/156

(57) ABSTRACT

A method and apparatus for executing a function using a combination of a user's key input and motion in a terminal such as a mobile phone. The method includes receiving a key input from a user, sensing a motion of the user using a sensor, recognizing a pattern of the sensed motion, and executing a function corresponding to a combination of the key input and the recognized motion pattern.

### CROSS-REFERENCE TO RELATED APPLICATIONS

This application claims the priority of Korean Patent Application No. 2004-0079202, filed on Oct. 5, 2004, and the priority of Korean Patent Application No. 2004-0115071, filed on Dec. 29, 2004, in the Korean Intellectual Property Office, the disclosures of which are incorporated herein by reference.

### BACKGROUND OF THE INVENTION

1. Field of the Invention

The present invention relates to a method of and apparatus for inputting a character and selecting a function in a terminal such as a mobile phone, and more particularly, to a method of and apparatus for inputting a character or executing a function using a combination of a user's key input and motion.

2. Description of Related Art

Usually, a user can input Korean characters, English characters, and numbers using a keyboard installed in a mobile phone. The number of keys on the keyboard is limited, and to input Korean and English characters, a plurality of Korean and English vowels/consonants are allocated to a single key. In addition, to repeatedly input one character among characters allocated to one key, a user must repeatedly press the same key at designated time intervals or must repeatedly press the same key and then another special key.

In particular, in a Korean character input method using a “cheon-ji-in” system (where “cheon”, “ji”, and “in” literally mean heaven, earth, and man, respectively), to repeatedly input one consonant among several consonants allocated to one key, a user must press the key once and then press the key once again after a designated period of time or must press the key and then press the key again after pressing a direction key. If the user presses the key again within the designated period of time after pressing the key, another consonant allocated to the key is input. English characters are input in the same manner. Accordingly, since the keys must be pressed a number of times to input a vowel or a consonant, the entire input time of a character can be long.

FIGS. 1A and 1B illustrate the structures of character input buttons of a mobile phone. A conventional method of entering characters will be described with reference to FIGS. 1A and 1B.

FIG. 1A illustrates the structure of English character input buttons of a mobile phone. A user can input three alphabetic characters using one button. For example, when entering the word “CLEAR”, a user consecutively presses a button 100 three times, then consecutively presses a button 110 three times, then consecutively presses a button 120 twice, then presses the button 100 once, and then consecutively presses a button 130 twice.

FIG. 1B illustrates the structure of Korean character input buttons of a mobile phone using the “cheon-ji-in” system. Two consonants or a single vowel can be entered using one button. For example, when entering the word [symbol] a user consecutively presses a button 140 twice, then presses a button 150 once, then presses a button 160 once, then consecutively presses a button 170 twice, presses a button 180 once, and the presses a button 190 once.

Recently, mobile phones having multiple functions so that a user can access wireless Internet to obtain information, listen to music, and take a photograph using the mobile phone have been introduced. Compared to the many functions added to the mobile phone, the number of keys provided in the mobile phone is limited. Accordingly, as a new function is added, the number of times that a user has to press a key to execute a function increases.

For example, to download the newest ringtone from the wireless Internet using a mobile phone, a user needs to press several buttons four times: a first time for connecting to the wireless Internet, a second time for selecting a My Bell menu after connecting to the wireless Internet, a third time for selecting a Ringtone menu under the My Bell menu, and a fourth time for selecting the Newest menu under the Ringtone menu.

As described above, when inputting characters or executing a function in a mobile phone using a conventional method, a user is inconvenienced by having to press several buttons many times. In particular, when inputting characters, since the user may need to consecutively and quickly press one button several times, many errors may occur and a considerable time may be spent on this activity.

### BRIEF SUMMARY

An aspect of the present invention provides a method of and apparatus for inputting a character or executing a function with a small number of key inputs by using a combination of a user's key input and motion.

According to an aspect of the present invention, there is provided a method of executing a function in a communication terminal, including receiving a key input from a user, sensing a motion of the user using a sensor, recognizing a pattern of the sensed motion, and executing a function corresponding to a combination of the key input and the recognized motion pattern.

The executing of the function may include generating a character corresponding to the combination of the key input and the recognized motion pattern, and displaying the generated character.

The recognizing of the pattern may include recognizing the pattern of the user's motion using an artificial neural network, template matching, a hidden Markov model, or a support vector machine (SVM).

The method may further include receiving one motion pattern among designated motion patterns, one key input among designated key inputs, and a function to be executed from the user; and matching a combination of the received motion pattern and the received key input with the received function.

Alternatively, the method may further include receiving a motion, one key input among designated key inputs, and a function to be executed from the user; and matching a combination of a pattern of the received motion and the received key input with the received function.

The sensing of the motion may include sensing the user's motion using at least one of an angular velocity sensor and an acceleration sensor.

The sensing of the motion may include sensing the user's motion using the sensor while the key input is being received from the user or using the sensor for a designated period of time after the user's key input.

The recognizing of the pattern may include recognizing a pattern of a trajectory of the sensed motion, and recognizing one among a designated number of motion patterns as the pattern of the sensed motion.

Alternatively, the recognizing of the pattern may include extracting a feature of the sensed motion, and recognizing one among a designated number of motion patterns based on the extracted feature.

The motion pattern may include a leftward motion, a rightward motion, and a standstill.

According to another aspect of the present invention, there is provided an apparatus for executing a function in a communication terminal, the apparatus including a key input unit generating and outputting a key input signal corresponding to a user's key input, a sensing unit sensing a motion of the user and generating a motion signal corresponding to the sensed motion, a pattern recognition unit recognizing a pattern of the user's motion based on the motion signal, a memory unit storing information regarding a function matched with a combination of a key input and a motion pattern, and a signal generation unit reading the information regarding a function matched with a combination of the key input signal and the recognized motion pattern from the memory unit and generating and outputting a signal corresponding to the function.

The signal generation unit may generate and output a signal corresponding to a character matched with the combination of the key input signal and the recognized motion pattern.

The apparatus may further include a pattern input unit receiving one motion pattern among designated motion patterns according from the user, a function input unit receiving a function to be executed from the user, and a first setting unit matching a combination of the motion pattern received from the pattern input unit and the user's key input received from the key input unit with the function received from the function input unit and storing the combination and the function in the memory unit.

Alternatively, the apparatus may further include a function input unit receiving a function to be executed from the user, and a second setting unit matching a combination of the user's motion received from the sensing unit and the user's key input received from the key input unit with the function received from the function input unit and storing the combination and the function in the memory unit.

The sensing unit may include at least one of an angular velocity sensor and an acceleration sensor and may sense the user's motion while the user's key input is being received and generate the motion signal corresponding to the sensed motion or may sense the user's motion for a designated period of time after the user's key input and generate the motion signal corresponding to the sensed motion.

The pattern recognition unit may recognize one among a designated number of motion patterns as the user's motion based on the motion signal and may recognize a pattern of a trajectory of the user's motion based on the motion signal.

The pattern recognition unit may include a feature extractor extracting a feature of the user's motion from the motion signal, and a pattern selector selecting one among a designated number of motion patterns based on the extracted feature.

The pattern recognition unit may recognize one among a designated number of motion pattern based on the motion signal using an artificial neural network, template matching, a hidden Markov model, or a SVM.

Learning may be performed according to the user's selection when the artificial neural network, the template matching, the hidden Markov model, and the SVM are used.

The motion pattern may include a leftward motion, a rightward motion, and a still motion.

According to another aspect of the present invention, there is provided an apparatus for setting a function to be executed by a combination of a key input and a motion pattern. The apparatus includes: a key input unit receiving the key input; a pattern selecting section selecting the motion pattern from among a number of motion patterns based on a received motion pattern or a sensed user motion; a function input unit receiving the function to be executed by the combination of the received key input and the selected motion pattern; and a setting unit setting a relationship between the combination and the received function.

According to another aspect of the present invention, there is provided a method of setting a function to be executed by a combination of a key input and a motion pattern. The method includes: receiving a key input; selecting the motion pattern from among a number of motion patterns based on a received motion pattern or a sensed user motion; receiving a function to be executed by the combination of the received key input and the selected motion pattern; and setting a relationship between the combination and the received function.

According to other aspects of the present invention, the aforementioned methods can be implemented using a computer readable recording media storing programs for executing the methods.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIGS. 1A and 1B illustrate the structures of character input buttons of a mobile phone;

FIG. 2 is a block diagram of a function input apparatus using a combination of a user's key input and motion according to an embodiment of the present invention;

FIG. 3 is a block diagram of an apparatus for allowing a user to set a particular function to be executed by a combination of a key input and a motion;

FIG. 4 illustrates a character input method using a combination of a user's key input and motion according to an embodiment of the present invention;

FIG. 5 illustrates a character input method using a combination of a user's key input and motion according to another embodiment of the present invention;

FIG. 6 illustrates a character input method using a combination of a user's key input and motion according to a still another embodiment of the present invention;

FIG. 7 is a table illustrating a method of executing a function of a mobile phone by combining a user's key input and motion according to an embodiment of the present invention;

FIGS. 8A through 8C illustrate graphs of an output signal of an inertial sensor with respect to a user's motion;

FIG. 9 illustrates examples of a user's motion trajectory;

FIG. 10 illustrates graphs of an output signal of an inertial sensor with respect to a user's motion trajectory shown in FIG. 9;

FIG. 11 is a block diagram of a pattern recognition unit included in the function input apparatus shown in FIG. 2;

FIG. 12 is a flowchart of a method of selecting a function using a combination of a user's key input and motion according to an embodiment of the present invention;

FIG. 13 is a flowchart of a method of setting a particular function to be executed by a combination of a key input and a motion according to an embodiment of the present invention; and

FIG. 14 is a flowchart of a method of setting a particular function to be executed by a combination of a key input and a motion according to another embodiment of the present invention.

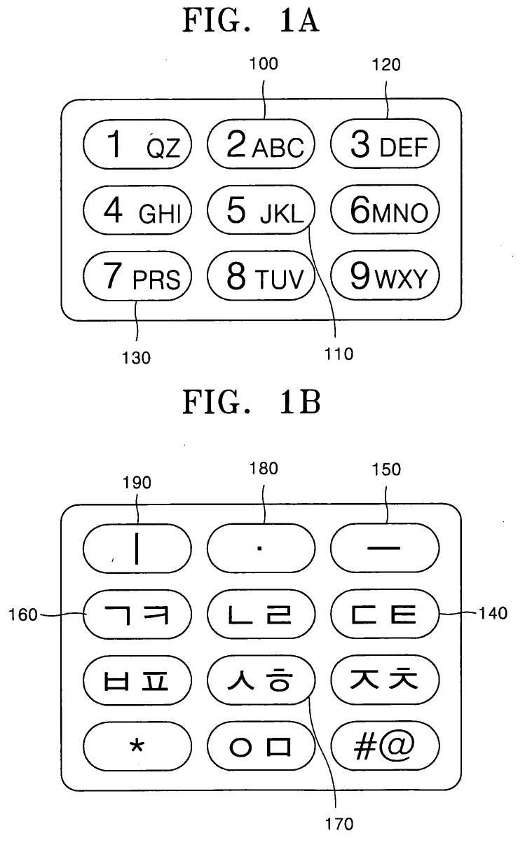

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

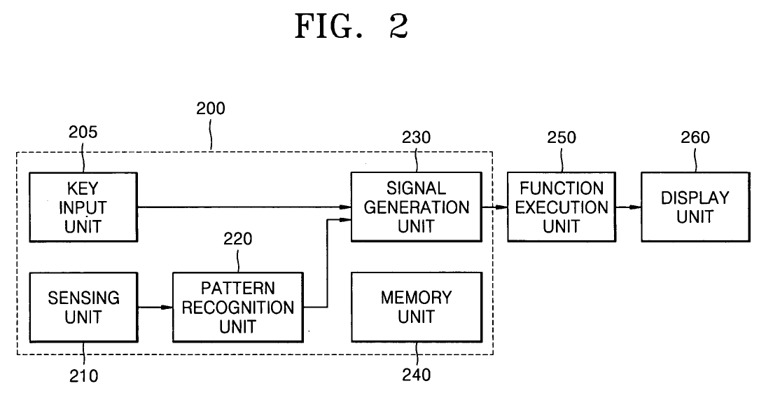

FIG. 2 is a block diagram of a function input apparatus 200 using a combination of a user's key input and motion according to an embodiment of the present invention. The function input apparatus 200 includes a key input unit 205, a sensing unit 210, a pattern recognition unit 220, a signal generation unit 230, and a memory unit 240.

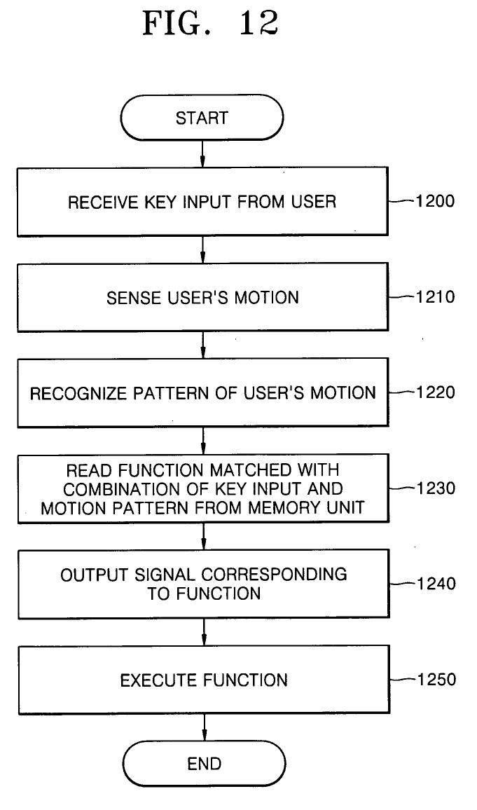

The operation of the function input apparatus 200 will be described in association with a flowchart shown in FIG. 12.

Referring to FIGS. 2 and 12, in operation 1200, the key input unit 205 receives a key input for entering a character or executing a function from a user and generates a key input signal corresponding to the key input. The key input unit 205 may include a button marked with a character, a wireless Internet connection button, or a menu button.

In operation 1210, the sensing unit 210 senses a hand motion of the user and generates a sensor output signal corresponding to the user's motion. The sensing unit 210 may include an angular velocity sensor sensing the angular velocity of the user's motion, an acceleration sensor sensing the acceleration of the user's motion, or both the angular velocity sensor and the acceleration sensor to simultaneously sense the angular velocity and the acceleration of the user's motion. Alternatively, the sensing unit 210 may include a magnetic compass sensor to sense the user's motion.

The angular velocity and acceleration of a mobile terminal, such as a mobile phone, vary with a user's motion, for example, a motion of the user's hand holding the mobile terminal when entering characters. Accordingly, an angular velocity sensor attached to the mobile terminal senses the angular velocity of the mobile terminal. That is, the angular velocity sensor senses whether the mobile terminal turns to the left or to the right, whether it turns up or down, or whether it turns clockwise or counterclockwise, and generates a sensor output signal corresponding to a sensed angular velocity. An acceleration sensor senses the acceleration of the mobile terminal, i.e., a change in the motion speed of the mobile terminal, and generates a sensor output signal corresponding to the sensed acceleration.

The sensing unit 210 may sense the user's motion only when the user is performing a key input operation using the key input unit 205, for example, while the user is pressing down a button of the key input unit 205, and generate a sensor output signal corresponding to the user's motion made during the pressing. Alternatively, the sensing unit 210 may sense the user's motion for a designated period of time after the user performs a key input operation using the key input unit 205, for example, for one second since the user releases a pressed button on the key input unit 205, and generate a sensor output signal corresponding to the user's motion during the designated period of time.

In operation 1220, the pattern recognition unit 220 receives a motion signal, i.e., the sensor output signal, from the sensing unit 210 and recognizes a pattern of the user's motion. In detail, the pattern recognition unit 220 may extract a feature of the motion signal, recognize one pattern from among a designated number of motion patterns stored in the memory unit 240 as a motion pattern of the user based on the feature of the motion signal, and generate a signal corresponding to the recognized motion pattern. The pattern of the user's motion may be recognized using, by way of non-limiting examples, an artificial neural network, template matching, a hidden Markov model, a support vector machine (SVM), etc.

The memory unit 240 stores a combination of a key input and a motion pattern to be matched with a particular character or function. For example, the memory unit 240 may store a combination of a menu input button and a rightward motion pattern to be matched with a ringtone change function.

In operation 1230, the signal generation unit 230 receives the key input signal from the key input unit 205 and the motion pattern from the pattern recognition unit 220 and reads a particular character or function that matches the combination of the key input and the motion pattern from the memory unit 240. In operation 1240, the signal generation unit 230 generates and outputs a signal corresponding to the particular character or function.

In operation 1250, a function execution unit 250 included in a device such as a mobile phone receives the signal from the signal generation unit 230 and generates the character corresponding to the signal or execute the function corresponding to the signal. When the character is generated, a display unit 260 included in the device may display the character on a screen to allow the user to view the entered character.

A key input, a motion pattern, and a character or function corresponding to a combination of the key input and the motion pattern may be set and stored in the memory unit 240 by a maker of a device such as a mobile phone during manufacturing, and a user purchasing the device may be provided with information regarding the character or function entered by the combination. Alternatively, a user purchasing a device may be allowed to store an arbitrary combination of a key input and a motion pattern in the memory unit 240 to be matched with a particular character or function.

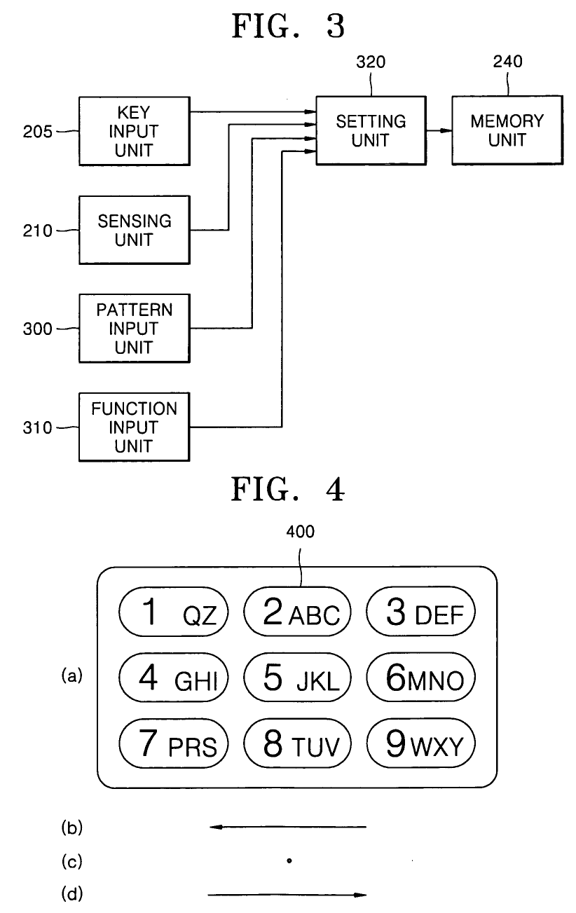

FIG. 3 is a block diagram of an apparatus for allowing a user to set a particular function to be executed by a combination of a key input and a motion. The apparatus shown in FIG. 3 includes a key input unit 205, a sensing unit 210, a pattern input unit 300, a function input unit 310, a setting unit 320, and a memory unit 240.

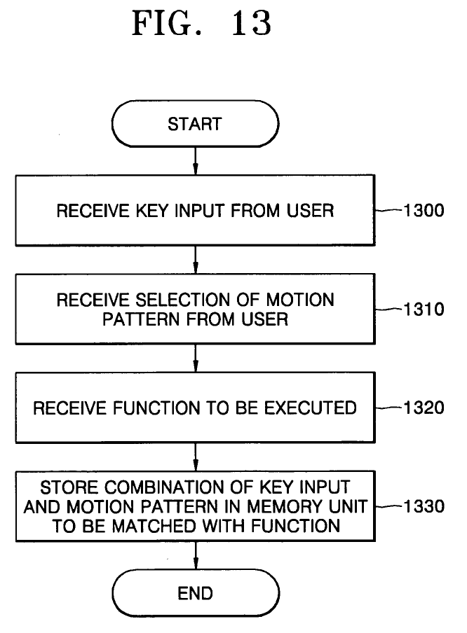

The operation of the apparatus shown in FIG. 3 will be described in association with FIG. 13, which is a flowchart of a method of setting a particular function to be executed by a combination of a key input and a motion according to an embodiment of the present invention.

Referring to FIGS. 3 and 13, in operation 1300, the key input unit 205 receives a key input for entering a character or function execution from a user. In operation 1310, the pattern input unit 300 selects a motion pattern from among a designated number of predefined motion patterns. Here, available motion patterns may be displayed to the user by the display unit 260, and then the pattern input unit 300 may select one motion pattern from the displayed motion patterns according to the user's input. Alternatively, the pattern input unit 300 may not be provided, and in operation 1310 a motion pattern may be selected by the user using a button included in the key input unit 205. For example, a motion pattern may be selected using number buttons, such as “1”, “2”, “3”, “4”, and “5” buttons, included in a mobile phone.

In operation 1320, the function input unit 310 receives from the user a function to be executed by a combination of the key input received in operation 1300 and the motion pattern selected in operation 1310. In operation 1320, the display unit 260 may display available functions to the user, and then the function execution unit 310 may receive a function selected by the user. Alternatively, the function input unit 310 may not be provided, and the function to be executed may be received from the user using buttons included in the key input unit 205.

In operation 1330, the setting unit 320 stores the combination of the key input and the motion pattern in the memory unit 240 to be matched with the received function.

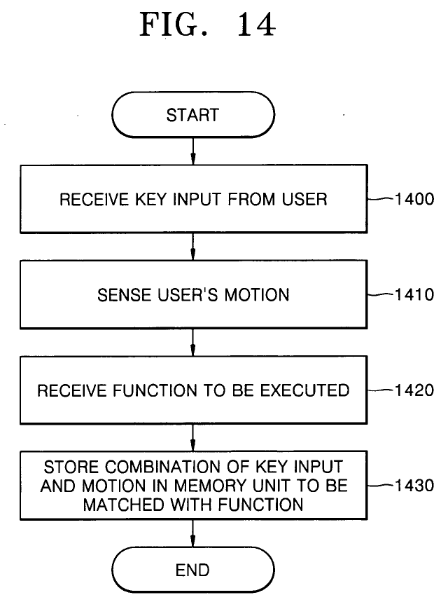

A method of setting a particular function to be executed by a combination of a key input and a motion according to another embodiment of the present invention will be described with reference to FIG. 14.

Referring to FIGS. 3 and 14, in operation 1400, the key input unit 205 receives a key input for entering a character or function execution from a user. In operation 1410, the sensing unit 210 senses a motion of the user intending to enter the character or function execution and outputs a motion signal corresponding to the sensed motion. It is preferable that the trajectory, direction, or magnitude of user's motion should not be restricted.

In operation 1420, the function input unit 310 receives from the user a function to be executed by a combination of the key input received in operation 1400 and the motion sensed in operation 1410. In operation 1430, the setting unit 320 stores the combination of the key input and the motion in the memory unit 240 to be matched with the received function. In operation 1420, the user may be made to make a desired motion at least twice, and a plurality of motion signals or a common feature to the plurality of motion signals may be stored in the memory unit 240.

When a function is set to a combination of a key input and a motion using the method illustrated in FIG. 14, it is possible to perform pattern recognition thereafter using template matching.

FIG. 4 illustrates a character input method using a combination of a user's key input and motion according to a first embodiment of the present invention. Three motion patterns, i.e., a leftward motion, a standstill, and a rightward motion, are predefined with respect to the user's motions.

If the user holding a mobile device having a sensor in his/her hand moves the mobile device to the left as illustrated in part (b) in FIG. 4 while pressing and holding down a button 400, “A” among characters marked on the button 400 is entered. If the user keeps the mobile device in a standstill as illustrated in part (c) in FIG. 4 while pressing and holding down the button 400, “B” is entered. If the user moves the mobile device to the right as illustrated in part (d) of FIG. 4, “C” is entered. As described above, the user's motion pattern may be recognized based on the user's motion made while the user is pressing down a button.

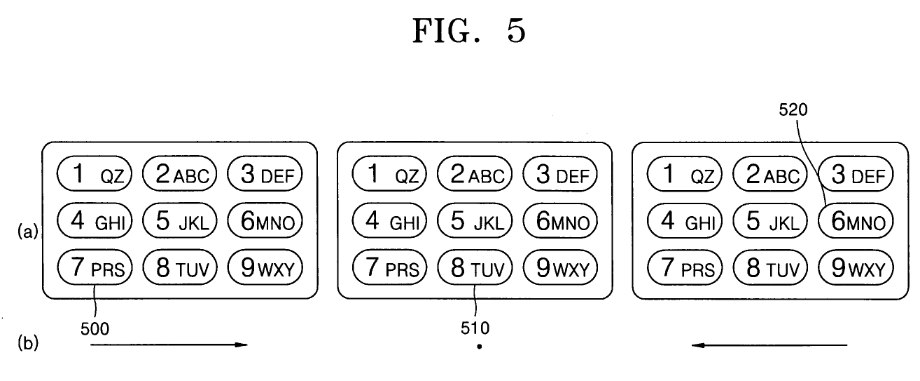

FIG. 5 illustrates a character input method using a combination of a user's key input and motion according to a second embodiment of the present invention. In FIG. 5, a row (a) shows key inputs of the user and a row (b) shows motion patterns of the user. In entering “SUM” in a mobile device, the user moves the hand holding the mobile device to the right while pressing and holding down a button 500. Then, the signal generation unit 230 combines the user's key input and motion pattern and generates a signal corresponding to “S”. Subsequently, the user keeps the mobile device in a standstill while pressing and holding down a button 510. Then, the signal generation unit 230 generates a signal corresponding to “U” according to a combination of the user's key input and motion pattern. Next, the user moves the hand holding the mobile device to the left while pressing and holding down a button 520. Then, the signal generation unit 230 generates a signal corresponding to “M”. Through such operations, the user can enter “SUM”.

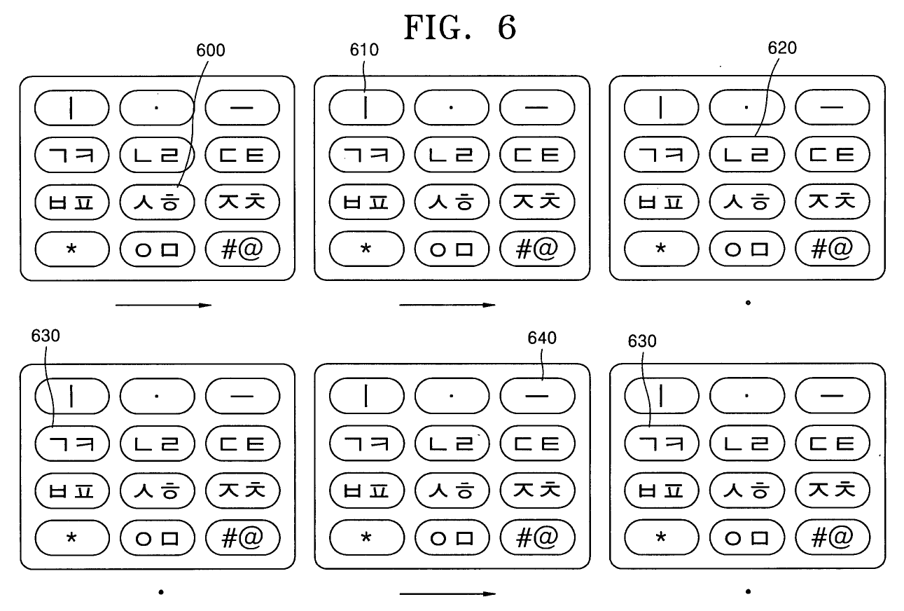

FIG. 6 illustrates a character input method using a combination of a user's key input and motion according to a third embodiment of the present invention. In FIG. 6, the Korean word [symbol] is entered.

When the user moves a mobile device to the right while pressing and holding down a button 600, a character [symbol] is entered. When the user moves the mobile device to the right while pressing and holding down a button 610, [symbol] is displayed through the display unit 260. When the user keeps the mobile device still at least a designated period of time while pressing and holding down a button 620, [symbol] is displayed through the display unit 260. Next, when the user keeps the mobile device in a standstill at least the designated period of time while pressing and holding down a button 630, a character [symbol] is entered. When the user moves the mobile device to the right while pressing and holding down a button 640, [symbol] is displayed through the display unit 260. When the user keeps the mobile device still at least the designated period of time while pressing and holding down the button 630, [symbol] is displayed through the display unit 260. Through such key inputs and motions, the user can enter [symbol] in the mobile device such as a mobile phone.

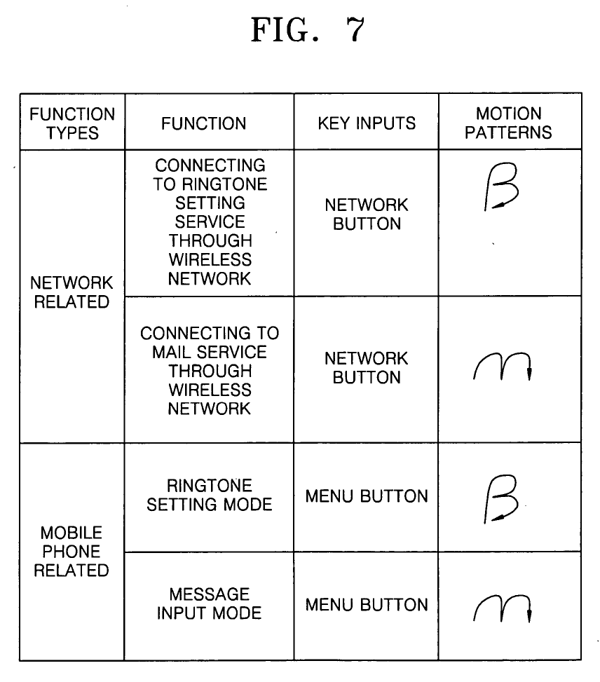

FIG. 7 is a table illustrating a method of matching a combination of a user's key input and a motion pattern with a function of a mobile phone according to an embodiment of the present invention. When a network button and a motion pattern B are input, a function of connecting the mobile phone to a ringtone setting service through a wireless network is executed in correspondence to the combination. When the network button and a motion pattern M are input, a function of connecting the mobile phone to a mail service through the wireless network is executed in correspondence to the combination.

When a menu button and the motion pattern B are input, a ringtone setting function is executed in correspondence to the combination. When the menu button and the motion pattern M are input, a message input function is executed in correspondence to the combination.

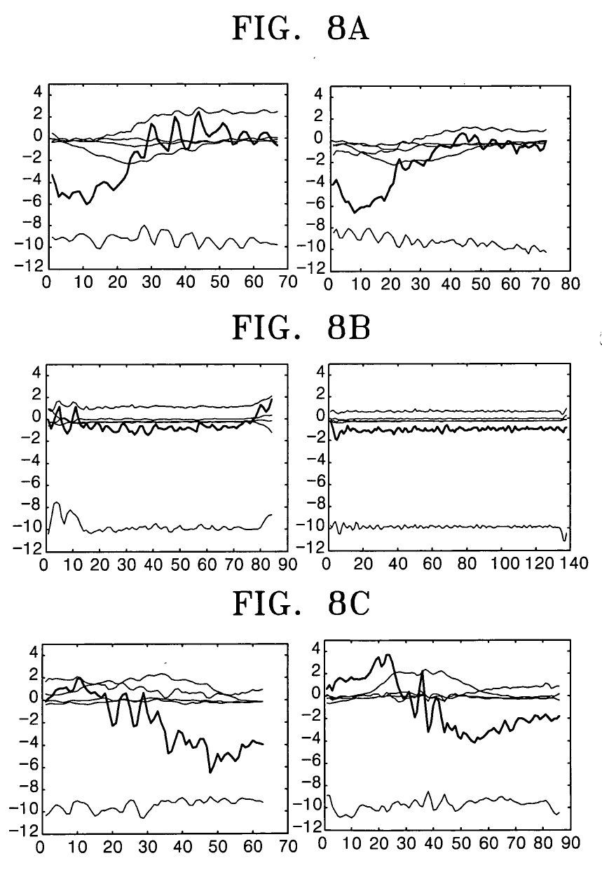

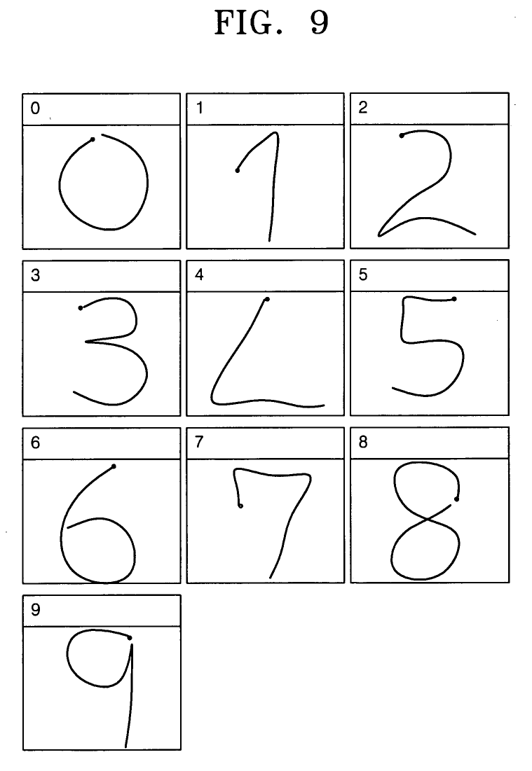

FIGS. 8A through 8C illustrate graphs of an output signal of an inertial sensor with respect to a user's motion. FIG. 8A illustrates graphs of output signals of an angular velocity sensor and an acceleration sensor, respectively, with respect to a user's leftward motion. FIG. 8B illustrates graphs of output signals of an angular velocity sensor and an acceleration sensor, respectively, with respect to a user's standstill motion. FIG. 8A illustrates graphs of output signals of an angular velocity sensor and an acceleration sensor, respectively, with respect to a user's rightward motion. Accordingly, three angular velocity sensor output signals and three acceleration sensor outputs are illustrated, and two output signals are illustrated with respect to each motion. Referring to FIGS. 8A through 8C, the leftward motion, the standstill motion, and the rightward motion can be distinguished from one another according to an output signal of a sensor.

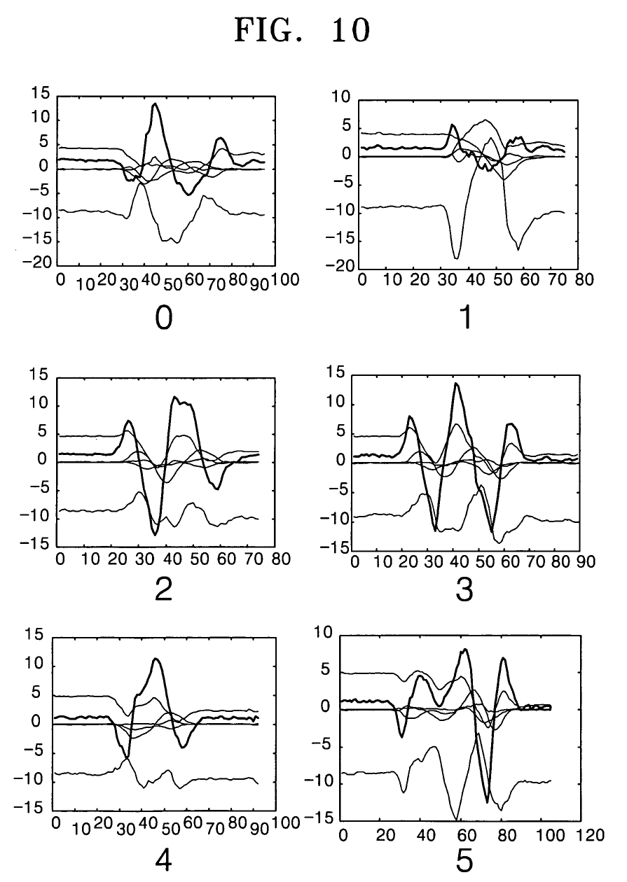

FIG. 9 illustrates examples of a user's motion trajectory. FIG. 10 illustrates graphs of output signals of an inertial sensor with respect to motion trajectories of numbers 0 through 5 among the motion trajectories shown in FIG. 9.

Hereinafter, a method by which the pattern recognition unit 220 shown in FIG. 2 recognizes a motion pattern from a motion signal sensed from a user's motion will be described in detail. The pattern recognition method is usually used as follows.

Firstly, a large amount of data on {Input X, Class C} is collected from a user. Secondly, the collected data is divided into learning data and test data. Thirdly, the learning data is provided to a pattern recognition system to perform learning. Then, model parameters of the pattern recognition system are changed in accordance with the learning data. Lastly, only Input X is provided to the pattern recognition system so that the pattern recognition system outputs Class C.

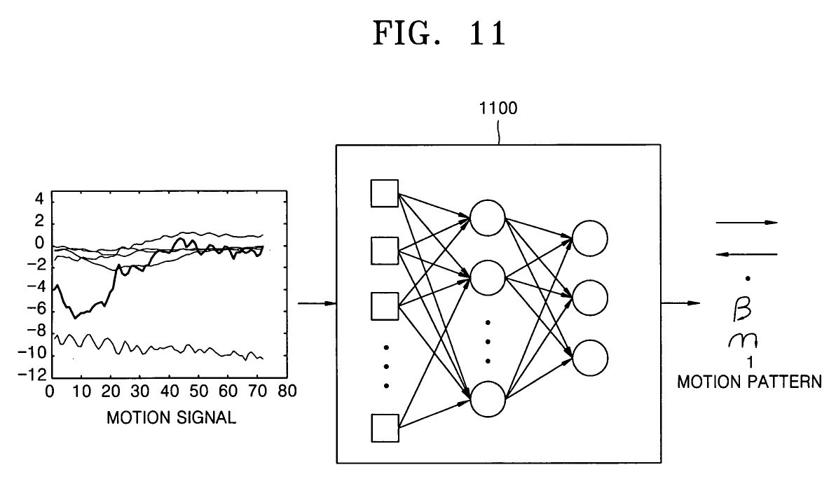

FIG. 11 is a block diagram of the pattern recognition unit 220 included in the function input apparatus shown in FIG. 2.

Referring to FIGS. 2 and 11, the pattern recognition unit 220 recognizes a motion pattern from a motion signal using an artificial neural network 1100. The pattern recognition unit 220 may recognize one among a plurality of designated motion patterns as a current user's motion pattern using the artificial neural network 1100. The artificial neural network 1100 is a model obtained by simplifying a neurotransmission process of an organism and analyzing it mathematically. In the artificial neural network 1100, an operation is analyzed through a sort of learning process in which weights on connections between neurons are adjusted according to the types of connections. This procedure is similar to a procedure in which people learn and memorize. Through this procedure, inference, classification, prediction, etc., can be carried out. In the artificial neural network 1100, a neuron corresponds to a node, and intensities of connections between neurons correspond to weights on arcs between nodes. The artificial neural network 1100 may be a multi-layer perceptron neural network including a plurality of single-layer perceptrons and may learn using back-propagation learning.

The back-propagation learning is created by generalizing a Widrow-Hoff learning rule to multiple-layer networks and nonlinear differentiable transfer functions and is usually used for character recognition and nonlinear prediction. Each node in a neural network uses one of diverse differentiable transfer functions to generate an output. A log sigmoid transfer function (i.e., logsig) shown in Equation 1 is most widely used.

$$f ( x ) = \frac{1}{1 + {ⅇ}^{- x}} \qquad ( 1 )$$

This function outputs a value ranging from 0 to 1 according to an input value ranging from minus infinity to plus infinity. A desired function is learned while a deviation between a desired output value and an actual output value is reduced using a back-propagation algorithm.

When a signal output from a sensor is input to nodes on an input layer of the artificial neural network 1100, the signal is changed in each node and then transmitted to a medium layer. In the same manner, the signal is transmitted to the final layer, which outputs a score of each motion pattern. Intensity of connection between nodes (hereinafter, referred to as “node connection intensity”) is adjusted such that a difference between activation values output from the artificial neural network 1100 and activation values defined for individual patterns during learning is reduced. In addition, according to a delta learning rule, a lower layer adjusts a node connection intensity based on a result of back-propagation on an upper layer to minimize an error. According to the delta learning rule, the node connection intensity is adjusted such that an input/output function minimizes the sum of squares of errors between a target output and outputs obtained from all individual input patterns in a network including nonlinear neurons.

After learning all of the designated motion patterns through the above-described leaning process, the artificial neural network 1100 receives a motion signal from the sensing unit 210 (FIG. 2) sensing a user's motion and recognizes the motion signal as one of the designated motion patterns.

The artificial neural network 1100 may be operated to relearn motion patterns according to a user's selection when necessary. For example, when a user selects a motion pattern to be relearned and makes a motion corresponding to the selected motion pattern a plurality of times, the artificial neural network 1100 may relearn the motion pattern reflecting the motion made by the user.

Alternatively, a user's motion pattern may be recognized using an SVM (Support Vector Machine). Here, N-dimensional vector space is formed from N-dimensional features of motion signals. After an appropriate hyperplane is found based on learning data, patterns can be classified using the hyperplane. Each of the patterns can be defined by Equation 2.
class=1 if W^{T}X+b≧0
class=0 if W^{T}X+b<0 (2)
where W is a weight matrix, X is an input vector, and “b” is an offset.

Alternatively, a motion pattern may be recognized using template matching. Here, after template data with which patterns are classified is selected from learning data, a template data item closest to a current input is found and the current input is classified into a pattern corresponding to the template data item. In other words, with respect to input data X=P(x₁, . . . xₙ) and an i-th data item Yᵢ=P(y₁, . . . yₙ) among the learning data, Y* can be defined by Equation 3.
Y*=minᵢ Distance(X, Yᵢ) (3)

Distance (X, Y) in Equation 3 can be calculated using Equation 4.

$$Distance ( X , Y ) = ‖ X - Y ‖ = \sqrt{{\sum }_{i = 1}^{n} {( {x}_{i} - {y}_{i} )}^{2}} \qquad ( 4 )$$

According to Equations 3 and 4, the input X is classified into a pattern to which data Y* belongs.

Alternatively, a motion pattern may be recognized using a hidden Markov model. The hidden Markov model is a set of states connected via transitions and output functions associated with each state. A model is composed of two kinds of probability: a transition probability needed for transition and an output probability indicating a conditional probability of observing an output symbol included in finite alphabet at each state. Since temporal-spatial change is represented with probabilities in a state and a transition, it is not necessary to additionally consider the temporal-spatial change in the reference pattern during a matching process.

Besides the above-described pattern recognition algorithms, it is to be understood that other diverse pattern recognition algorithms may be used in the present invention.

The above-described embodiments of the invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

According to the above-described embodiments of the present invention, a character is entered by combining a user's key input and motion, thereby increasing character input speed. In addition, more than a combinable number of characters or functions can be entered with a limited number of character input buttons, and therefore, a user is provided with convenience.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of executing a function in a communication terminal, the method comprising:
receiving a key input from a user;
sensing a motion of the user using a sensor;
recognizing a pattern of the sensed motion; and
executing a function corresponding to a combination of the key input and the recognized motion pattern.

2. The method of claim 1, wherein the executing includes generating a character corresponding to the combination of the key input and the recognized motion pattern.

3. The method of claim 2, further comprising displaying the generated character.

4. The method of claim 1, wherein the recognizing includes recognizing the pattern of the user's motion using one selected from the group consisting of an artificial neural network, template matching, a hidden Markov model, and a support vector machine (SVM).

5. The method of claim 1, further comprising:
receiving one motion pattern among designated motion patterns, one key input among designated key inputs, and a function to be executed from the user; and
matching a combination of the received motion pattern and the received key input with the received function.

6. The method of claim 1, further comprising:
receiving a motion, one key input among designated key inputs, and a function to be executed from the user; and
matching a combination of a pattern of the received motion and the received key input with the received function.

7. The method of claim 1, wherein the sensing includes sensing the user's motion using an angular velocity sensor or an acceleration sensor.

8. The method of claim 1, wherein the sensing includes sensing the user's motion using the sensor while the key input is being received from the user.

9. The method of claim 1, wherein the sensing includes sensing the user's motion using the sensor for a designated period of time after the user's key input.

10. The method of claim 1, wherein the recognizing includes recognizing a pattern of a trajectory of the sensed motion.

11. The method of claim 1, wherein the recognizing includes recognizing one of a designated number of motion patterns as the pattern of the sensed motion.

12. The method of claim 1, wherein the recognizing includes:
extracting a feature of the sensed motion; and
recognizing one among a designated number of motion patterns based on the extracted feature.

13. The method of claim 1, wherein the motion pattern includes a leftward motion, a rightward motion, or a standstill.

14. An apparatus for executing a function in a communication terminal, the apparatus comprising:
a key input unit generating and outputting a key input signal corresponding to a user's key input;
a sensing unit sensing a motion of the user and generating a motion signal corresponding to the sensed motion;
a pattern recognition unit recognizing a pattern of the user's motion based on the motion signal;
a memory unit storing information regarding a function matching a combination of a key input and a motion pattern; and
a signal generation unit reading the information regarding a function matching the combination of the key input signal and the recognized motion pattern from the memory unit and outputting a signal corresponding to the function.

15. The apparatus of claim 14, wherein the signal generation unit generates and outputs a signal corresponding to a character matched with the combination of the key input signal and the recognized motion pattern.

16. The apparatus of claim 14, further comprising:
a pattern input unit receiving one motion pattern among designated motion patterns according from the user;
a function input unit receiving a function to be executed from the user; and
a first setting unit matching a combination of the motion pattern received from the pattern input unit and the user's key input received from the key input unit with the function received from the function input unit and storing the combination and the function in the memory unit.

17. The apparatus of claim 14, further comprising:
a function input unit receiving a function to be executed from the user; and
a second setting unit matching a combination of the user's motion received from the sensing unit and the user's key input received from the key input unit with the function received from the function input unit and storing the combination and the function in the memory unit.

18. The apparatus of claim 14, wherein the sensing unit includes at least one of an angular velocity sensor and an acceleration sensor.

19. The apparatus of claim 14, wherein the sensing unit senses the user's motion while the user's key input is being received and generates the motion signal corresponding to the sensed motion.

20. The apparatus of claim 14, wherein the sensing unit senses the user's motion for a designated period of time after the user's key input and generates the motion signal corresponding to the sensed motion.

21. The apparatus of claim 14, wherein the pattern recognition unit recognizes one among a designated number of motion patterns as the user's motion based on the motion signal.

22. The apparatus of claim 14, wherein the pattern recognition unit recognizes a pattern of a trajectory of the user's motion based on the motion signal.

23. The apparatus of claim 14, wherein the pattern recognition unit includes:
a feature extractor extracting a feature of the user's motion from the motion signal; and
a pattern selector selecting one among a designated number of motion patterns based on the extracted feature.

24. The apparatus of claim 14, wherein the pattern recognition unit recognizes one among a designated number of motion pattern based on the motion signal using one selected from the group consisting of an artificial neural network, template matching, a hidden Markov model, and a support vector machine (SVM).

25. The apparatus of claim 24, wherein the pattern recognition unit learns according to the user's selection when the artificial neural network, the template matching, the hidden Markov model, and the SVM are used.

26. The apparatus of claim 14, wherein the motion pattern includes a leftward motion, a rightward motion, and a still motion.

27. A computer-readable storage medium encoded with processing instructions for causing a processor to perform a method of executing a function in a communication terminal, the method comprising:
receiving a key input from a user;
sensing a motion of the user using a sensor;
recognizing a pattern of the sensed motion; and
executing a function corresponding to a combination of the key input and the recognized motion pattern.

28. An apparatus for setting a function to be executed by a combination of a key input and a motion pattern, comprising:
a key input unit receiving the key input;
a pattern selecting section selecting the motion pattern from among a number of motion patterns based on a received motion pattern or a sensed user motion;
a function input unit receiving the function to be executed by the combination of the received key input and the selected motion pattern; and
a setting unit setting a relationship between the combination and the received function.

29. The apparatus of claim 28, wherein the pattern selecting section includes sensing unit sensing a motion intending to enter a character or to execute a function.

30. The apparatus of claim 28, wherein the pattern selecting section includes a pattern input unit receiving an input motion pattern.

31. A method of setting a function to be executed by a combination of a key input and a motion pattern, comprising:
receiving a key input;
selecting the motion pattern from among a number of motion patterns based on a received motion pattern or a sensed user motion;
receiving a function to be executed by the combination of the received key input and the selected motion pattern; and
setting a relationship between the combination and the received function.

32. A computer-readable storage medium encoded with processing instructions for causing a processor to perform a method of setting a function to be executed by a combination of a key input and a motion pattern, the method comprising:
receiving a key input;
selecting the motion pattern from among a number of motion patterns based on a received motion pattern or a sensed user motion;
receiving a function to be executed by the combination of the received key input and the selected motion pattern; and
setting a relationship between the combination and the received function.
